(19) United States
(12) Patent Application Publication
(10) Pub. No.: US 2014/0121927 A1
(43) Pub. Date: May 1, 2014

(54) VEHICLE EMERGENCY EVACUATION DEVICE

(71) Applicant: Kiyoto Hanita, Susono-shi (JP)

(72) Inventor: Kiyoto Hanita, Susono-shi (JP)

(21) Appl. No.: 13/499,091

(22) PCT Filed: Jul. 11, 2011
(86) PCT No.: PCT/JP11/65819

§ 371 Date: Mar. 29, 2012

(51) Int. Cl. B60T 7/12

(52) U.S. Cl. CPC B60T 7/12
USPC 701/70

(57) ABSTRACT

In a vehicle emergency evacuation device executing an automatic vehicle stop control based on a command of the driver through a switch or a command input device in a driver's emergency, there is provided a switch or a command input device which is easy to operate when a driver's body condition is abnormal or deteriorates but does not erroneously receive a command input when the driver's body condition is normal. The inventive emergency evacuation device comprises a driver's condition monitoring portions, such as a driver camera; a driver's command input portion that has a receptor put on a position accessible for the driver and receiving a command input indicating a driver's intention, and outputs a command of an execution start of an automatic vehicle stop control based on the command input; and an automatic vehicle stop control portion executes the automatic vehicle stop control in response to the command from a driver's command input portion, where, only when an abnormality in a driver's body condition is judged based on the information acquired by the driver's condition monitoring portion, such as a driver's image acquired with the driver camera, the command input is acceptable to the receptor.

### TECHNICAL FIELD

The present invention relates to an emergency evacuation device of a vehicle, such as an automobile, which device stops a vehicle automatically in a driver's emergency, more specifically to a switch or a command input device operated by a driver for an execution start of the automatic vehicle stop control used in the emergency evacuation device.

### BACKGROUND ART

In the field of the driving support technique for vehicles, such as automobile, there is proposed an emergency evacuation device which executes an emergency evacuation process to stop the vehicle automatically during the driving of a vehicle irrespective of a braking operation of a driver (an operation of a brake pedal, etc.), when the continuation of its driving becomes difficult due to an abnormality, a deterioration, etc. of the driver's body condition. For example, in the patent document 1, it is described to detect a driver's consciousness lowering (a symptom of napping) by measuring a driver's heart rate, a time period without steering, a time period without blinking, etc. (through monitoring a driver's face with a camera) and to execute an automatic vehicle stop control when driver's consciousness lowering repeatedly occurs even if the driver is prompted to awake. In the patent document 2, it is also proposed to execute an automatic stop of a vehicle at a deceleration, set in consideration of the possibility of a collision with a frontward obstacle, when a driver's reaction is absent or dull even if a warning for awake is given at a detection of a driver's nap based on a pulse (sphygmus) change or when the driver requests by himself the automatic vehicle stop through a switch or a command input device because of feeling the difficulty in keeping the driving due to an abnormality in his/her body. Further, the patent document 3 proposes a vehicle stopping device constructed such that a driver's consciousness lowering or napping is judged by using a camera to detect if a driver's face has not turned toward the vehicle front or if driver's eyes have been closed continuously for a predetermined time, etc., or based upon a driver's heart rate and respiration rate, and then, if the driver's consciousness lowering or napping is judged, the vehicle is automatically led to and stopped at a safely stoppable site through the determination of the situation around the vehicle, the width of a roadside or a road shoulder, or the position of an obstacle with detection means, such as an on-vehicle camera, a radar sensor, a navigation system and a vehicle-to-vehicle communication.

Further, with respect to an emergency evacuation device, as a technique of detecting a deterioration, etc. of a driver's body condition during driving a vehicle, in the non-patent document 1, it is proposed to measure the direction of a face or the direction of a visual axis of a driver from an image of a driver's face captured with a video camera in use for an interface, such as the warnings of front inattention or the prevention from napping. Moreover, in the patent document 4, there is proposed a riding person's posture estimation device in which a driver's posture is estimated from positions of body parts, such as shoulders, elbows and hands of the driver in an image captured with a vehicle room camera.

### PRIOR REFERENCE

### Patent Documents

[Patent document 1] Japanese Patent Laid-open Publication H06-107031
[Patent document 2] Japanese Patent Laid-open Publication H07-76235
[Patent document 3] Japanese Patent Laid-open Publication 2007-331652
[Patent document 4] Japanese Patent Laid-open Publication 2010-211705

### Non-Patent Document

[Non-patent document] Yoshio Matsumoto, Other three, Information Processing Society of Japan Magazine Computer vision and Image media Vol. 47, No. SIG15(CVIM 16) October, 2006, p10-21

### SUMMARY OF INVENTION

### Object of the Invention

In an emergency evacuation device as described above, in order to make it possible for a driver to request an automatic stop of a vehicle (automatic vehicle stop control), for instance, it is proposed to provide a switch or a command input device to which the driver can give a command of an execution start of an automatic vehicle stop control with his intention when he senses an abnormality of his body. With respect to such a switch or a device for a driver's command input, in a case that a driver requests an automatic vehicle stop control, it can be surmised that, usually, an abnormality or a deterioration of the body condition occurs in the driver so that his athletic ability is lowered. Thus, it is preferable that a switch or a device for a command input of a driver is designed and arranged to be easily accessible even for the driver having the deteriorated body condition. However, in a structure easy to make a command input, an erroneous input would be easily given to a switch or a device for command input when a driver's condition is normal, which can be an origin of an erroneous operation of an automatic vehicle stop control. Namely, it is preferable that a switch or a device for a command input of a driver is designed to be not easily given command inputs when the driver is in a normal condition, but easily given command inputs when the driver is in an abnormal condition, however, in conventional emergency evacuation devices, it seems that no such structures are seen in switches or command input devices for a driver to give a command of an execution start of an automatic vehicle stop control.

Accordingly, one major object of the present invention is to provide an emergency evacuation device of a vehicle, which device executes an automatic vehicle stop control in response to an input of a driver himself through a switch or a command input device in an emergency of the driver, wherein the switch or command input device is designed to be easily given a command input when a driver's body condition is deteriorating or abnormal.

Furthermore, a further object of the present invention is to design a switch or a command input device, to be operated by a driver, of an emergency evacuation device of a vehicle as described above such that command inputs are not erroneously given to the switch or command input device when the driver's body condition is normal.

### The Means for Solving the Object

According to the present invention, the above-mentioned objects are achieved by an emergency evacuation device that executes an automatic vehicle stop control of a vehicle, comprising: a driver's condition monitoring portion that acquires information on a condition of a driver; a driver's command input portion that has a receptor put on a position accessible for the driver and receiving a command input indicating an intention of the driver of a request for the automatic vehicle stop control, and outputs a command of an execution start of the automatic vehicle stop control based on the command input; and an automatic vehicle stop control portion that executes an automatic vehicle stop control in response to the command from the driver's command input portion, wherein the command input becomes acceptable to the receptor only when an abnormality of a body condition of the driver is judged based on the information acquired by the driver condition monitoring portion. In this regard, “automatic vehicle stop control” is a control process that decelerates and stops a vehicle irrespective of braking operation (operation of a brake pedal, etc.) of a driver. And, “a command input indicating an intention of the driver of a request of an automatic vehicle stop control” is a command indicating a request for an execution of the automatic vehicle stop control given e.g. by a driver pressing a receptor. Moreover, the driver's condition monitoring portion may be a driver camera which captures an image of a driver, and in this case, the judgment of an abnormality in a driver's body condition may be done based on a driver's image acquired by the driver camera. Or, the driver's condition monitoring portion may be similar to an arbitrary device which can detect information indicating a driver's physiological conditions, such as an electroencephalogram, a heart rate, a sweat rate, a blood pressure, components in expiration, etc., and an abnormality in the driver's body condition may be judged based on those detected information.

The above-mentioned inventive device is basically designed to be capable of stopping a vehicle automatically in accordance with an input from a driver indicating a request for automatic stopping of a vehicle given to the receptor of the driver's command input portion (namely, a switch or an command input device) when the driver feels that the continuation of driving is difficult owing to the abnormality or deterioration of his own body condition. However, as already noted, when the driver's body condition is abnormal or deteriorating, it is surmised that the athletic ability of the driver has been lowered, and thus, even in such a condition, a command input should be easily given to a receptor by the driver; however, if a command input can be easily given to the receptor even when the driver's body condition is normal, for instance, a contact to the receptor unintended by the driver would induce an erroneous recognition of the conducting of a command input, and thereby an execution of the automatic vehicle stop control would be started erroneously. Then, in order to avoid such an erroneous operation of an automatic vehicle stop control, the inventive device is designed to monitor a driver's body condition with the driver's condition monitoring portion, such as a driver camera capturing an image of a driver, and to make the receptor enabled to receive a command input from the driver only when an abnormality or a deterioration of the body condition is detected. That is, in the inventive device, the operation to the receptor(s) is permitted only when an abnormality or a deterioration of the body condition is detected, and any operation to the receptors is forbidden when an abnormality or a deterioration of the body condition is not detected. According to this structure, even if a driver of normal condition contacts or presses a receptor (or a site capable of functioning as a receptor), this operation will not be recognized as a command input, and therefore erroneous operation of the automatic vehicle stop control will be prevented.

The above-mentioned receptor receiving a command input may be a switch of an arbitrary form, and when a command input is acceptable, namely when no abnormality or deterioration of the driver's body condition is detected, the receptor may have a function different from the receiving of a command input. In the other words, an arbitrary switch which already exists around a driver's seat, such as a windshield wiper switch etc., may be diverted as the above-mentioned receptor for receiving a command input from the driver when an abnormality or a deterioration of the driver's body condition is detected. Moreover, in an alternate manner, a touch panel used for a navigation system, etc., equipped in front of the driver's seat may be used as a receptor which receives a command input. In that case, a receptor for receiving a command input is displayed on the touch panel equipped in front of the driver's seat when a command input is acceptable, and not displayed on the touch panel when a command input is not acceptable. And, only when the receptor receiving a command input is displayed on the touch panel, if the driver contacts or presses the touch panel, this operation is recognized as a command input of an execution of the automatic vehicle stop control. In a case as described above that an input device, such as the existing arbitrary switch or the touch panel, is diverted as the receptor, it becomes unnecessary to provide a receptor separately, which is advantageous in costs and in designing. In this respect, other than a touch panel, etc., a receptor which receives a command input may be an arbitrary device that appears in a position accessible for a driver only when a command input is acceptable. For example, the receptor may be a button, etc. not exposed outside by being covered with a lid member when a command input is not acceptable, but becoming exposed outside to be operable for the driver by the lid member being removed off when a command input becomes acceptable.

In the above-mentioned structure of the present invention, as noted above, the monitoring of the driver's body condition may be performed by an arbitrary method, e.g. by the method described in the non-patent document 1 or the patent document 4, using a detected image of the face and/or the upper half body in a driver's image captured with the driver camera. In that case, the driver's body condition is judged abnormal when the time for which the driver's face determined based on a driver's image has turned downward exceeds beyond a predetermined time. Here, the predetermined time may be, for example, the longest time for which a face has turned downward, assumed in a normal condition, and it may be experimentally determined beforehand. Further, in a case that the posture of the upper half of the driver's body, especially, whether or not a hand is put on a steering wheel, can be judged as well as the direction of the driver's face, the above-mentioned predetermined time when it is judged based on the driver's image that the driver's hand is not put on the steering wheel may be set shorter than the predetermined time when the driver's hand is put on the steering wheel. The reason of this changing of the predetermined time is because, in a case that the driver has turned his face downward and the driver's hand is not put on a steering wheel, the driver's body condition has deteriorated in higher extent than in a case that the driver has turned the face downward only, and therefore it is preferable to execute an automatic vehicle stop control immediately. In this connection, while the above-mentioned judgment is basically performed during the running of the vehicle, namely, when the vehicle speed >0, the judgment may be performed during the vehicle stopped, and in that case, the stopped state of the vehicle is maintained.

### Effect of Invention

Thus, the above-mentioned inventive device is designed to monitor a driver's body condition, and to receive from a driver a command input indicating a request for the automatic vehicle stop control when an abnormality of a driver's body condition is detected but not to receive the command input when the driver's body condition is normal, so that it becomes possible to prevent the erroneous operation of the automatic vehicle stop control when the driver's body condition is normal. Moreover, since the receptor which receives a command input from a driver in the inventive device is basically designed to receive a command input only when the driver's body condition is abnormal or deteriorating, the arrangement or construction of the receptor(s) can be made such that even a driver having a deteriorating body condition can easily access the receptor(s), and, when a driver's body condition becomes abnormal, a request for an automatic vehicle stop control is accepted promptly and an execution of the control can be started, and thereby the improvement in the safety of a vehicle is expected. In this regard, it should be understood that the structure in the inventive device that the driver's command input portion outputs a command of an execution start of an automatic vehicle stop control based on a command input from a driver to a receptor and the execution of an automatic vehicle stop control is started in response to the command does not prevent the control manner of starting an execution of an automatic vehicle stop control in accordance with the other situations without waiting for the command input from the driver.

The other purposes and advantages of the present inventions will become clear by explanation of the following preferable embodiments of the present inventions.

### BRIEF EXPLANATION OF THE DRAWINGS

FIG. 1 shows in the form of a block diagram a system configuration which consists of an emergency evacuation device of a vehicle in accordance with the present invention and a group of devices related thereto.

FIG. 2 (A) is a schematic diagram of an image of a driver's face camera. In the drawing, a black dot with an arrow shows a characteristic point detected in the face. FIG. 2 (B) is a schematic perspective diagram of a three-dimensional face model set in detecting the direction of a face.

FIG. 3 are drawings showing schematically images of a steering wheel in images of a camera for the upper half body of a driver. (A) shows a condition that a driver's hand is put on the steering wheel, and (B) shows a condition that no driver's hand is put on the steering wheel.

FIG. 4 shows in a form of a flow chart an embodiment of a judgment processing for determining whether or not to enable receptor(s) which receives a driver's command input, executed in the judgment process portion of an emergency evacuation device in accordance with the present invention.

### EXPLANATIONS OF REFERENCE NUMERALS

100—Driver's head
S—Steering wheel
H—Position of a driver's hand

### THE BEST MODE FOR INVENTION

In the followings, the present invention is explained in detail about some preferable embodiments, referring to the attached drawings.

The vehicle's emergency evacuation device in accordance with the present invention, briefly speaking, is a device that automatically executes a process which brings and stops a vehicle adjacent to a roadside, a lane edge, etc. so as not to involve the circumferences when it becomes difficult for a driver to continue driving the vehicle due to a sudden illness or an indisposition during the driving of the vehicle (an emergency evacuation process by an automatic vehicle stop control). Especially, in the present invention, as explained in detail later, a receptor 70a or 70b of a driver's command input portion 70 to which a driver gives a command input of a request for an execution of an automatic vehicle stop control is controlled to be capable of receiving the command input only when a deterioration or an abnormality of a driver's body condition is detected. Hereafter, the structure and operation of the inventive emergency evacuation device are explained in detail.

### (a) General Structure

A vehicle on which the vehicle's emergency evacuation device is installed may be an arbitrary vehicle, such as an automobile. On the vehicle, there are installed in usual manners a powering device that generates a braking-driving force in each wheel, a steering device, and a braking device which generates a braking force in each wheel (not shown). The powering device, braking device and steering device each may be designed to be operated by a control device (a driving control device, a braking control device, a steering control device) that changes and controls a braking-driving force or a steering angle in accordance with a command from a running control portion aside from an operation input by a driver.

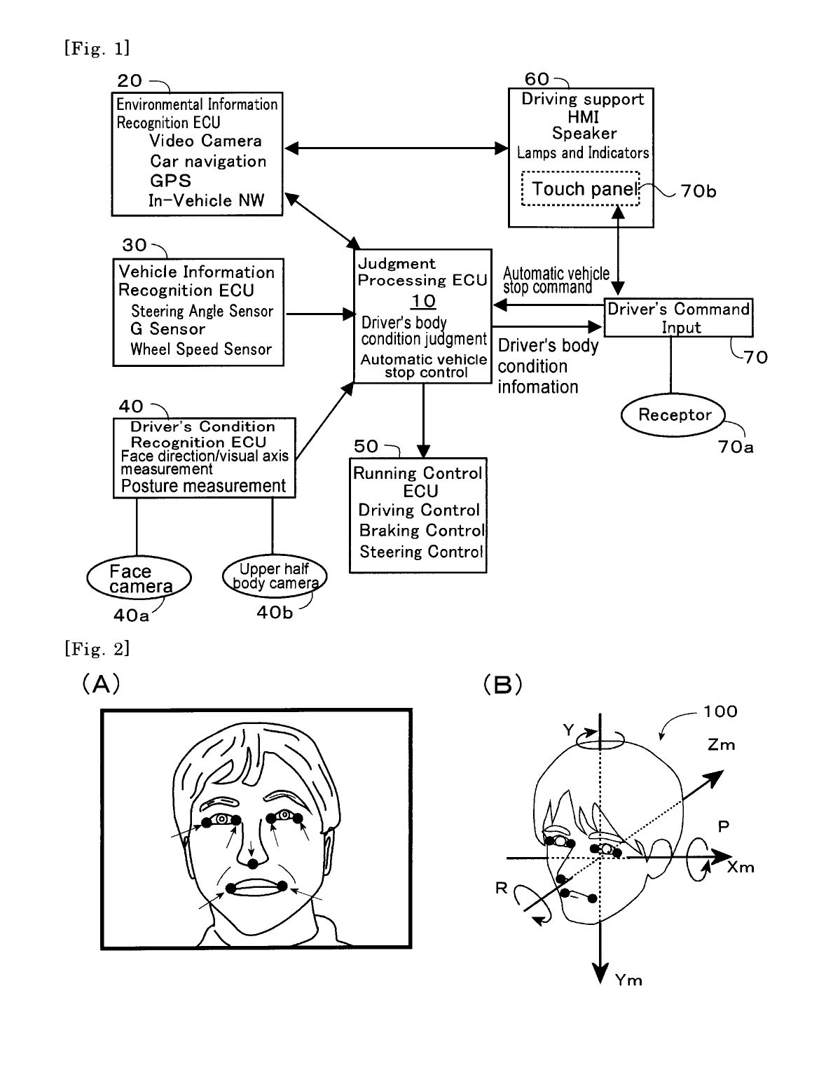

FIG. 1 (A) shows in the form of a block diagram a system configuration of the vehicle emergency evacuation device and devices involved therewith. Referring to this drawing, in the vehicle emergency evacuation device, the body condition of a driver, such as a deterioration of the body condition and the presence or absence of a consciousness lowering, is monitored during the running of the vehicle based on information or data from a driver's condition recognition portion 40 (driver's condition recognition ECU) using a face camera 40a which captures an image of a driver's face and a upper half body camera 40b which captures an image of the posture of a driver's upper half body. Then, when an abnormality or a deterioration of the driver's body condition is judged in the manner explained later, this information is sent to a driver's command input portion 70, and the driver's command input portion 70 enables a receptor 70a (makes the receptor capable of receiving a command input from the driver) and/or makes a touch panel 70b, etc. function as a receptor of the driver's command input portion 70. Thus, when the driver gives a command input e.g. by pressing the receptor 70a or 70b, the driver's command input portion 70 judges the presence of a request for an automatic vehicle stop control from the driver, and this information is transmitted to a judgment processing ECU 10. The judgment processing ECU 10, when receiving the command of the automatic vehicle stop control, sends a command to a running control portion 50 (running control ECU) which executes the braking-driving control and steering control of the vehicle by means of information or data from an environmental information recognition portion 20 (environmental information recognition ECU) for detecting conditions around the vehicle and a vehicle information recognition portion 30 (vehicle information recognition ECU) for detecting the running condition of the vehicle in order to perform the deceleration and stopping of the vehicle to a safely stoppable site, and also operates a speaker or a lamplight and an indicator in a driving support HMI (Human Interface) 60 in order to make the driver, riding person(s) or the other vehicle around the vehicle recognize the execution of an automatic vehicle stop control process.

In the automatic vehicle stop control, briefly speaking, after determining an execution start of the control, a vehicle is decelerated and brought into a safely stoppable site selected or determined by taking into account circumferential conditions acquired from the environmental information recognition portion 20. In the determination of a safely stoppable site, more in details, a region in which influence on the circumference is as small as possible in the deceleration and stopping of the vehicle is grasped using information from a car-navigation system about a road shape and/or position(s) of a road crossing, a railroad crossing and/or a pedestrian crossing around the vehicle, information acquirable with a vehicle-to-vehicle communication, etc. about the position and velocity of the other vehicle(s) around the own vehicle, and/or information detected by means of an image of a video camera, an output of a circumference recognition sensor (a radar sensor, a millimeter wave sensor, etc.), etc. about the position and distance of a roadside or a road shoulder, the position and distance of an obstacle, or the position of white line on a road surface; and within the region, there is selected a site on which the vehicle can be stopped without difficulty by deceleration and steering from the current running condition of the vehicle acquirable in the vehicle information recognition portion ECU. For manners of concrete control processes, for example, the descriptions in the patent document 3 or PCT/JP2011/052289 of the present applicant may be referred to.

In this connection, each of the above-mentioned ECUs may include a microcomputer of a usual form having CPU, ROM, RAM and input/output port apparatus, and a drive circuit, mutually connected with bidirectional common bus. The processing operations in the respective ECUs explained below are realized by the operation according to computer programs of the respective ECUs.

### (b) Face Direction and Visual Axis Measurement Portion

As noted above, for one structure for monitoring an abnormality or a deterioration of a driver's body condition, in this embodiment, an image of the driver's face is captured and the direction of the face and/or the direction of a visual axis of the driver are detected from the image. The face camera 40a which captures an image of a driver's face is mounted on an arbitrary position, for example, in the vicinity of a hub of a steering wheel or a front panel (not shown), and images of a driver's face as schematically drawn in FIG. 2 (A) are captured sequentially during the running of the vehicle (in the time of the vehicle speed >0). Then, the images of the driver's face obtained sequentially are sent to a face direction and visual axis measurement portion (image processing device), where the direction of the driver's face is sequentially measured e.g. by any method as described in the non-patent document 1.

In the measurement of the direction of a face, for example, first, the detection of the area of the image of a face and characteristic points in the face, namely, positions of right and left inner eye corners, right and left outer eye corners, the center of a nose and right and left mouth corners, etc. and/or right and left irises or pupils, etc. (black dot points with arrows in FIG. 2 (A)), is executed in every sequentially obtained image by means of a neural network and a learning algorithm (Boosting, etc.). Next, to the above-mentioned area of the image of the face and characteristic points in the face, there is fitted a three-dimensional face model 100 having the positions of the corresponding characteristic points defined therein as schematically drawn in FIG. 2 (B) to determine the face model's direction providing the highest respective correspondences of the area of the image of the face and the characteristic points in the face between the captured image and the face model, and under this condition, the absolute position of the face (the face camera is being fixed.) and the angles in the rotational directions (roll directions R, yaw direction Y, pitch direction P) are measured. Moreover, the direction of the visual axis may be determined from the positions of right and left irises or pupils and the eyeball center positions estimated from the positions of the right and left, inner and outer eye corners. Then, from the absolute position and rotational angles of the face and the direction of the visual axis measured sequentially as described above, it is judged sequentially whether or not the face has turned downward. In this regard, in the judgment of whether or not the face has turned downward, when the absolute position and rotational angles of the face and the direction of the visual axis each have been downward beyond predetermined ranges (which may be determined experimentally.) from the conditions that the face has turned toward the usual front direction, it may be judged that the face has turned downward.

### (c) Posture Measurement Portion

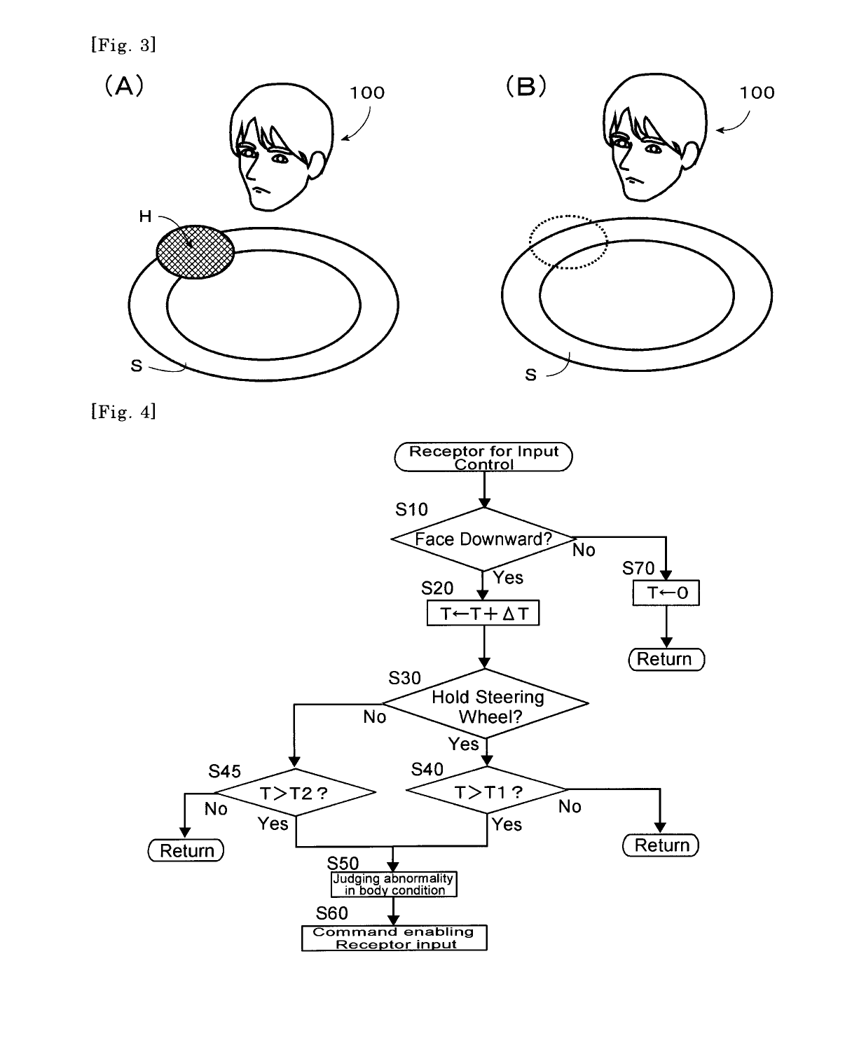

As another structure for monitoring an abnormality or a deterioration of a driver's body condition, in this embodiment, whether or not a driver's hand is put on the steering wheel is monitored e.g. by capturing an image of a driver's upper half body. The upper half body camera 40b which captures an image of the driver's upper half body is mounted, for example, on a pillar above the driver's seat or a roof; sequentially acquires images including an image of a steering wheel during the running of the vehicle (when the vehicle speed >0); and transmits the images to a posture measurement portion (image processing device). In the posture measurement portion, images of an arm, a hand, a head of the driver and a steering wheel, as schematically drawn in FIG. 3, are detected in the images received sequentially by an arbitrary method, e.g, a method given in the patent document 4, using a neural network and a learning algorithm (Boosting etc.), and it is detected whether or not the image of a driver's hand H exists in the image S of the steering wheel. In this detection of the image of the hand H of the driver in the image S of the steering wheel, the position and luminance pattern of the image of the steering wheel in the angle of view of the camera are memorized beforehand, and, when the difference between the luminance pattern of the image S of the steering wheel in the image during the driving and the luminance pattern of the image of the steering wheel memorized beforehand exceeds beyond a predetermined threshold value (see FIG. 3 (A)), it may be judged that the image H of the driver's hand exists in the image S of the steering wheel; and when the difference between the luminance pattern of the image S of the steering wheel in the image during the driving and the luminance pattern of the image of the steering wheel memorized beforehand does not exceeds beyond a predetermined threshold value (see FIG. 3 (B)), it may be judged that the driver's hand is detached from the steering wheel. In this connection, the judgment of whether or not a driver's hand is put on a steering wheel can be done by referring to an output of a pressure sensor mounted on the steering wheel. Thus, in this embodiment also, the presence or absence of a driver's hand on a steering wheel may be judged by referring to an output of a pressure sensor together with or instead of the method using the image of the upper half body camera.

### (d) Control of Enabling a Receptor

The information, detected sequentially by the face direction and visual axis measurement portion, on whether or not the driver's face has turned downward and the information, detected sequentially by the posture measurement portion, on whether or not the driver's hand is put on the steering wheel are sent to the judgment processing ECU 10 and used for the judgment of whether or not the driver's body condition is abnormal or deteriorating and the judgment of whether or not the receptor receiving a driver's command input for an execution of automatic vehicle stop control is to be enabled. In those judgment processes, briefly speaking, when the time for which the driver's face has turned downward exceeds beyond a first predetermined time, the deterioration of the driver's body condition is judged and the receptor(s) are enabled. Furthermore, in a case that not only the driver's face has turned downward but also the driver's hand is not put on the steering wheel, if this condition continues for a second predetermined time shorter than the first predetermined time, it is judged that the driver's body condition has deteriorated and the receptor(s) are enabled. This is because, in the condition that not only the driver's face has turned downward but also the driver's hand is not put on the a steering wheel, the degree of the deterioration of the driver's body condition is higher than in the condition that the driver's hand is put on the a steering wheel although the driver's face has turned downward, and therefore it is preferable to execute an automatic vehicle stop control more promptly. The above-mentioned judgment process is shown in FIG. 4 in a form of a flow chart. In this regard, the process of FIG. 4 is repetitively executed in a predetermined cycle time ΔT during the running of the vehicle, namely, when the vehicle speed >0.

Referring to this drawing, in the process of FIG. 4, first, it is checked if the information from the face direction and visual axis measurement portion indicates that the driver's face has turned downward (Step 10). If the face has turned downward, the value of a timer T is increased by ΔT (Step 20). Next, it is checked if the information from the posture measurement portion indicates the condition that the driver's hand is put on the steering wheel, namely the condition that the driver holds the steering wheel with hand(s) (Step 30). Then, if the condition that the face has turned downward and the driver holds the steering wheel continues, the process cycle of FIG. 4 will be repeated until the value of the timer T exceeds beyond a predetermined time T1 (step 40). Here, during the repeating of the process of FIG. 4, when the direction of the driver's face turns forward, the value of the timer T is reset to 0 (step 70). However, when the value of the timer T exceeds beyond the predetermined time T1, it is considered that the driver's body condition has become abnormal (It is abnormal if the face has turned downward continuously for a certain time even during the vehicle running.), and therefore, the judgment of the presence of an abnormality in the body condition will be made (step 60). Further, in step 30, when the information from the posture measurement portion indicates the condition that the driver's hand is not put on the steering wheel, namely the driver does not hold the steering wheel, it is judged whether or not the value of the timer T exceeds beyond a predetermined time T2 which is shorter than the predetermined time T1, and, when the value of the timer T exceeds beyond the predetermined time T2, the judgment of the presence of an abnormality in the body condition will be made (step 60). As noted, in a case that the driver's face has turned downward and the driver does not hold the steering wheel, the possibility that the deterioration of the body condition is advancing is high in comparison with a case that the driver holds the steering wheel. Then, when the driver does not hold the steering wheel, an abnormality in the body condition is judged at an early stage before the value of the timer T reaches the predetermined time T1.

Thus, as noted, when the judgment of an abnormality in the driver's body condition has been made, a command for enabling a receptor is transmitted from the judgment processing ECU 10 to the driver's command input portion 70, and the driver's command input portion 70 executes the enabling of the selected receptor(s). The receptor(s) may be a switch of an arbitrary form, and arranged on a position(s) easy for the driver to access (preferably, for example, a site located in the direction of the driver's visual axis). When a switch specialized for this purpose is provided, it may designed such that the contacting, pressing or other operation thereof is recognized as a command input for an automatic vehicle stop control execution only when the judgment of an abnormality in the body condition has been made, while the contacting or pressing is ignored when no judgment of an abnormality in the body condition has been made. Furthermore, a switch having the other function in a normal condition (when no judgment of an abnormality in the body condition has been made), such as a windshield wiper switch, a horn switch, other switch mounted on the steering wheel may be diverted as the receptor when the judgment of an abnormality in the body condition has been made. In that case, an operation of those switches when the judgment of an abnormality in the body condition has been made will be recognized as a command input of an automatic vehicle stop control execution. Moreover, an interface of a navigation system, such as touch panel, etc. may be designed to function as the receptor when the judgment of an abnormality in the body condition has been made. In that case, for example, when the judgment of an abnormality in the body condition has been made, it is displayed on a touch panel that it has become a receptor for an automatic vehicle stop control execution, and the contacting, pressing or other operation to the touch panel by the driver will be recognized as a command input of an automatic vehicle stop control execution.

When a command input of an automatic vehicle stop control execution is made through the receptor, the driver's command input portion 70 transmits a command of a request for an automatic vehicle stop control to the judgment processing ECU 10, and in response to this, the judgment processing ECU 10 starts an execution of an automatic vehicle stop control in an arbitrary manner. In this respect, in order to reconfirm the intention of the execution of the automatic vehicle stop control with the driver prior to the actual starting of the execution of the automatic vehicle stop control, it may be requested for the driver to give again a command input to the receptor (Intention confirmation process).

Thus, according to the above-mentioned structure, the receptor which receives from a driver a command input to an execution of an automatic vehicle stop control as an emergency evacuation process is enabled when the driver's body condition deteriorates, but disabled in a normal condition, and therefore, an automatic vehicle stop control is easily executable when the execution of the automatic vehicle stop control is necessary, while it is prevented to execute erroneously the automatic vehicle stop control under a normal condition. It should be understood that the receptor can be put on a position easy for a driver to access because the receptor is enabled when a driver's body condition deteriorates. Thereby, even in the condition that the driver's athletic ability is lowered owing to the deterioration of the driver's body condition, a command input is promptly made so that an automatic vehicle stop control can be executed, expecting the improvement in the vehicle running safety.

Although the above explanations have been made with respect to embodiments of the present invention, it will be apparent for those skilled in the art that various modifications and changes are possible, and that the present invention is not limited to the above-illustrated embodiments and may be applied to various devices and apparatus without deviating from the concepts of the present invention.

For instance, even during a vehicle stopped, the body condition may be monitored with a driver's image, and the stopped state is maintained when an abnormality or a deterioration of the body condition is detected. Further, an abnormality or a deterioration of a driver's body condition is detected based upon detected data of an electroencephalogram, a heart rate, a sweat rate, a blood pressure and components in expiration of a driver.

1. An emergency evacuation device that executes an automatic vehicle stop control of a vehicle, comprising:
a driver's condition monitoring portion that acquires information on a condition of a driver;
a driver's command input portion that has a receptor put on a position accessible for the driver and receiving a command input indicating an intention of the driver of a request for the automatic vehicle stop control, and outputs a command of an execution start of the automatic vehicle stop control based on the command input; and
an automatic vehicle stop control portion that executes an automatic vehicle stop control in response to the command from the driver command input portion,
wherein the command input becomes acceptable to the receptor only when an abnormality of a body condition of the driver has been judged based on the information acquired in the driver condition monitoring portion.

2. The device of claim 1, wherein the receptor for receiving the command input has a function different from receiving the command input when the command input is not acceptable.

3. The device of claim 1, wherein the receptor for receiving the command input is displayed on a touch panel installed in front of a driver's seat of the vehicle when the command input is acceptable, and not displayed when the command input is not acceptable

4. The device of claim 1, wherein, only when the command input is acceptable, the receptor for receiving the command input appears in a position accessible for the driver.

5. The device of claim 1, wherein the driver's condition monitoring portion is a driver camera which captures an image of the driver, and, when a time for which a face of the driver has turned downward determined based on the image of the driver acquired with the driver camera is beyond a predetermined time, it is judged that a body condition of the driver is abnormal.

6. The device of claim 5, wherein the predetermined time when it is judged based on the driver's image that a hand of the driver is not put on a steering wheel is shorter than the predetermined time when it is judged the hand of the driver is put on the steering wheel.
